(19) United States
(12) Patent Application Publication
(10) Pub. No.: US 2026/0262568 A1
(43) Pub. Date: Sep. 10, 2026

(54) Cutting head

(71) Applicant: Andreas Stihl AG & Co. KG, Waiblingen (DE)

(72) Inventors: Klaus Kaupp, Waiblingen (DE); Sebastian Schmidt, Kirchheim a. N. (DE); Ulli Lenz, Weinstadt (DE); Sven Leix, Erkenbrechtsweiler (DE); Lars Widmann, Auenwald (DE)

(73) Assignee: Andreas Stihl AG & Co. KG, Waiblingen (DE)

(21) Appl. No.: 19/556,008

(22) Filed: Mar. 4, 2026

(30) Foreign Application Priority Data
Mar. 5, 2025 (DE) 102025108429.7

(51) Int. Cl. A01D 34/416; A01D 34/67

(52) U.S. Cl. CPC A01D 34/4162; A01D 34/67

(57) ABSTRACT

A cutting head includes a housing, a shaft receiver with a receiving space for attaching the cutting head to an output shaft of a working device, a spool for receiving at least one cutting line, an adjusting device. The adjusting device is formed to adjust a free cutting line length of a cutting line depending on the centrifugal force. The cutting head comprises a grip element and a coupling device. The coupling device includes an operating position and a winding position. In the winding position of the coupling device for winding a cutting line the grip element and the housing can be rotated relative to each other with respect to the axis of rotation of the cutting head and the grip element and the spool are connected by the coupling device in a rotationally fixed manner.

### CROSS-REFERENCE TO RELATED APPLICATION

This application claims the benefit of German Patent Application DE 102025108429.7, filed on Mar. 5, 2025, the content of which is incorporated by reference in its entirety.

### TECHNICAL FIELD

The disclosure relates to cutting heads for motor-driven outdoor power tools used for cutting vegetation, particularly brush cutters, grass trimmers, and similar rotary cutting devices.

### BACKGROUND

From the prior art, a cutting head is known which comprises a housing and a shaft mount for attaching the cutting head to an output shaft of a power tool, in particular a brush cutter. The cutting head is driven via the output shaft around a rotational axis of the cutting head in a rotational direction. Furthermore, the cutting head comprises a spool which is arranged inside the housing. The spool serves to receive a cutting line. As the cutting head rotates, the cutting line also rotates around the axis of rotation. With the free ends of the cutting line, which protrude from the housing of the cutting head, the operator of the brush cutter can cut grass, brush, or similar.

During operation of the cutting head, the cutting line wears down, whereby the free ends of the cutting line shorten. To readjust the free ends of the cutting line, the cutting head comprises an adjusting device. By means of this device, the free cutting line length of the cutting line is readjusted depending on the centrifugal force.

A disadvantage of the known cutting head is that winding the spool is only possible in an extremely inconvenient manner. The operator has to remove the spool from the housing, wind the spool, and then reinstall the spool into the housing. The cutting line often unwinds from the spool due to its own tension. Often, the spool even has two spool chambers, each with one end of the cutting line wound onto it. Keeping the ends of the cutting line taut on such a spool, either for winding the cutting lines or for installing the spool in the housing, is particularly difficult. If the operator does not hold the cutting line securely enough, this can lead to the cutting lines unwinding. Often, the operator needs to make several attempts before they can attach the spool with the wound cutting line to the cutting head.

### SUMMARY

An object of the disclosure is to specify a cutting head of the generic type, which, along with the automatic thread readjustment during operation of the cutting head, also enables a comfortable winding of the spool of the cutting head. This object is solved by a cutting head as disclosed hereafter.

The cutting head comprises a housing, a shaft receiver with a receiving space for attaching the cutting head to an output shaft of a working device, wherein the cutting head can be driven in a rotational direction around an axis of rotation of the cutting head via the output shaft, a thread spool arranged in the housing for receiving at least one cutting line, an adjusting device, wherein the adjusting device is formed to readjust a free cutting line length of a cutting line depending on the centrifugal force. The cutting head comprises a grip element and a coupling device. The grip element is accessible to the operator in a mounted state of the cutting head. The coupling device comprises an operating position and a winding position, wherein in the operating position of the coupling device the grip element and the housing are connected to each other in a rotationally fixed manner by the coupling device with respect to the axis of rotation of the cutting head. In the winding position of the coupling device, the grip element and the housing can be rotated relative to each other with respect to the axis of rotation of the cutting head for winding a cutting line. In addition, in the winding position of the coupling device for winding a cutting line, the grip element and the thread spool are connected in a rotationally fixed manner by the coupling device.

The cutting head thus comprises an adjusting device by which the free cutting line can be automatically lengthened during operation of the cutting head. Moreover, the cutting head comprises a coupling device. This coupling device comprises a winding position and an operating position. If the coupling device is in the winding position, the operator can conveniently wind the cutting line onto the thread spool, wherein here the spool is held in the housing. The cutting line is attached to the spool. In the winding position of the coupling device, the grip element and the housing can be rotated relative to each other with respect to the axis of rotation of the cutting head. In order to wind the cutting line onto the spool, the operator, for example, holds the housing of the cutting head firmly with their one hand and rotates the grip element with their other hand in the rotational direction relative to the axis of rotation of the cutting head. Since, in the winding position of the coupling device, the grip element and the spool are connected to each other in a rotationally fixed manner by the coupling device, the spool also rotates relative to the housing of the cutting head. Here, the cutting line winds onto the spool. The cutting line is guided over the housing and the spool in such a way that accidental unwinding or jumping off of the cutting line from the spool can be avoided. The operator can easily wind the cutting line.

If the cutting line is wound onto the spool, the coupling device can be switched to the operating position. The operating position is provided to allow the cutting head to be rotated around its axis of rotation by a working device, and to cut grass or brush by means of the free cutting line sections. For this purpose, the grip element and the housing are connected to each other in a rotationally fixed manner by the coupling device in relation to the axis of rotation of the cutting head. Via the adjusting deice, cutting line is readjusting when the free cutting line sections fall below a predetermined length. The readjustment is carried out in centrifugal force-driven manner. Thus, the readjustment is carried out automatically.

The cutting head thus enables the automatic readjustment of the cutting line and, at the same time, a comfortable winding of the cutting line onto the spool, while the spool is held in the housing of the cutting head.

It is provided, in particular, that the coupling device has a connecting element for the rotationally fixed connection of the housing and the grip element, and the coupling device comprises a switching unit, wherein the connecting element can be switched between the winding position and the operating position by the switching unit. The connecting element is preferably formed as a connecting ring. The connecting element is, in particular, aligned coaxially with the axis of rotation of the cutting head. The connecting element preferably surrounds the shaft receiver. The connecting element is, in particular, connected to the shaft receiver in a rotationally fixed manner and is, in particular, moveably mounted relative to the shaft receiver in the direction of the axis of rotation of the cutting head.

It is preferably provided that the switching unit has at least one switching element, wherein, in the winding position of the coupling device, the at least one switching element projects with its one end into the receiving space of the shaft receiver in such a way that it can be actuated by the output shaft into the operating position of the coupling device when an output shaft is inserted. If the cutting head is pushed onto the output shaft, the switching element is automatically actuated by the output shaft, such that the coupling device is switched into the operating position.

The at least one switching element is formed, in particular, as a pivot lever, wherein the pivot lever is arranged and pivotably mounted on the shaft receiver, wherein the pivot lever can be actuated via the one end in the receiving space of the shaft receiver, and wherein another end of the pivot lever acts on the connecting element. In the operating position of the coupling device, the connecting element is preferably positively connected to the housing, in particular by means of a front toothed connection, in a rotationally fixed manner. If the cutting head is pushed onto the output shaft, this penetrates into the receiving space of the shaft receiver and contacts the one end of the switching element, in particular the pivot lever. The switching element, in particular the pivot lever, pivots around an axis of rotation, such that the one end of the pivot lever is at least partially pushed out of the receiving space by the output shaft. The other end of the switching element, in particular the pivot lever, consequently also moves and here acts on the connecting element. This is pushed against the housing via the other end of the switching element, wherein the connecting element and the housing here form a positive-locking connection. If the cutting head is pulled from the output shaft, the one end of the switching element, in particular the pivot lever, can pivot back into the receiving space of the shaft receiver, whereby the positive locking connection between the connecting element and the housing is broken.

It is provided, in particular, that the adjusting device comprises at least one pawl, which is arranged fixedly on the housing in the direction of the axis of rotation, and the adjusting device comprises an actuating element with at least one pawl stop, said actuating element being connected to the spool in a rotationally fixed manner, wherein the pawl is formed in such a way that it evades the pawl stop depending on the centrifugal force, whereby the spool is rotated relative to the housing and feeds in the cutting line. The adjusting device comprises, in particular, a spring that pretensions the pawl into a locked position. The pawl comprises, in particular, an actuating weight that exerts a corresponding torque on the pawl depending on the centrifugal force and counteracts the pretension of the spring. When the length of the free cutting line section is reduced, the centrifugal forces acting on the cutting line are also reduced. Thus, the torque that tensions the pawl stops, which are connected to the spool in a rotationally fixed manner, against the pawls is also reduced. The actuation weight of the pawl, the spring, and the length of the free cutting line section are coordinated to one another, in particular, in such a way that if the free cutting line section falls below a predetermined minimum length, the pawl disengages from the pawl stop, and the relative rotation of the spool and the housing is permitted. Here, the cutting line is readjusted until the pawl again abuts on a pawl stop.

It is provided, in particular, that the actuating element comprises a winding contour and an adjustment contour different to the winding contour, wherein the at least one pawl has a guide element which, depending on the direction of rotation of the actuating element relative to the housing, interacts either with the winding contour or the adjustment contour. The winding contour and the adjustment contour, through the guidance of the guide element, ensure a forced movement of the pawl. Thus, for example, the adjustment contour of the actuating element prevents the pawl from skipping a pawl stop. As a result of the winding contour, a rotation of the spool in the direction of rotation can be ensured while the housing remains stationary.

It is provided, in particular, that the actuating element has a crossing section where the winding contour and the adjusting contour intersect, wherein a locking element releases either the winding contour or the adjusting contour depending on the direction of rotation. In doing so, the two contours can run on a common plane relative to a plane aligned perpendicularly to the axis of rotation of the cutting head, and simultaneously remain distinct from each other. The forced guidance of the pawl is thus different for the respective contour and thus adapted to the intended purpose. The locking element has, in particular, a radial surface with respect to the axis of rotation, which is part of the adjusting contour. In addition, the actuating element has, in particular, an axial surface with respect to the axis of rotation of the cutting head, which is part of the winding contour. The locking element is formed, in particular, as a tongue that is spring-loaded in the axial direction with respect to the axis of rotation.

A further disadvantage of the cutting head known from the prior art is that too much cutting line is fed to the free cutting line section when the cutting line is adjusted. Working devices, such as brush cutters, motor sensors, and similar, usually comprise a cutting blade. If the cutting line is advanced, it is guided against a blade and cut as the cutting head rotates, such that the free cutting line section is limited to a predetermined length. The disadvantage here is that the cutting line is consumed without being used.

A further object of the disclosure is to specify a cutting head of the generic type, which allows an improved, automatic readjustment of the cutting line. This object is solved by a cutting head as disclosed hereafter.

The cutting head comprises a housing, a shaft receiver with a receiving space for attaching the cutting head to an output shaft of a working device, wherein the cutting head can be driven in a direction of rotation around an axis of rotation of the cutting head via the output shaft, a thread spool arranged in the housing for receiving at least one cutting line, an adjusting device which is formed in such a way that a free cutting line length of a cutting line can be adjusted depending on the centrifugal force by allowing a relative rotation between the thread spool and the housing, wherein the adjusting device comprises at least two pawls which are centrifugally actuated and are formed to be fixed relative to the housing in the direction of the axis of rotation, and wherein the cutting head has at least one pawl stop which is formed to be rotationally fixed relative to the thread spool with respect to the axis of rotation of the cutting head, wherein the housing is connected in a rotationally fixed manner to the thread spool in the direction of rotation of the cutting head when at least one of the at least two pawls rests against the at least one pawl stop, wherein the housing can be rotated relative to the thread spool in the direction of rotation of the cutting head when none of the at least two pawls are in contact with the at least one pawl stop, wherein the number of the at least one latch stop is not a multiple of the number of the at least two latches, and wherein the at least two pawls and the at least one pawl stop are arranged in relation to each other in such a way that the at least two latches are alternately in engagement with the at least one pawl stop.

By means of the alternating engagement of the several pawls, the length by which the free cutting line section is to be extended can be shortened, in particular halved, without increasing the number of pawl stops or the number of pawls. Adjusting the cutting line is subject to a significantly finer adjustment increment. The finer adjustment increment can be achieved without the use of additional components, for example further pawls. Due to the finer adjustment increment, the free cutting line section is extended by only short cutting line segments. Thus, the consumption of unused cutting line segments is considerably reduced, for example by cutting the free cutting line section to length by means of a cutting knife.

It is provided, in particular, that the adjusting device comprises at least one pawl, which is arranged fixed to the housing in the direction of the axis of rotation, and the adjusting device comprises an actuating element with at least one pawl stop, which is connected to the spool in a rotationally fixed manner, wherein the pawl is formed in such a way that it yields to the pawl stop depending on the centrifugal force, whereby the spool rotates relative to the housing and feeds cutting line. The adjusting device comprises, in particular, a spring that pretensions the pawl into a locked position. The pawl comprises, in particular, an actuating weight that exerts a corresponding torque on the pawl depending on the centrifugal force and counteracts the pre-tensioning of the spring. When the length of the free section of cutting line is reduced, the centrifugal forces which act on the cutting line are also reduced. Thus, the torque that tensions the pawl stops, which are connected to the spool in a rotationally fixed manner, against the pawls is also reduced. The actuation weight of the pawl, the spring, and the length of the free cutting line section are coordinated, in particular, in relation to one another in such a way that if the free cutting line section falls below a predetermined minimum length, the pawl disengages from the pawl stop, and a relative rotation of the thread spool and the housing is permitted. Here, the cutting line is then readjusted until the pawl again abuts on a pawl stop.

It is provided, in particular, that the actuating element comprises a winding contour and an adjustment contour distinct from the winding contour, wherein the at least one pawl has a guide element which, depending on the direction of rotation of the actuating element relative to the housing, interacts either with the winding contour or the adjustment contour. The winding contour and the adjustment contour, through the guidance of the guide element, ensure a forced movement of the pawl. Thus, as a result of the adjustment contour of the actuating element, the pawl is prevented from skipping the pawl of a pawl stop. By means of the winding contour, a rotation of the thread spool in the direction of rotation is ensured while the housing remains stationary.

It is provided, in particular, that the actuating element has a crossing section where the winding contour and the adjusting contour intersect, wherein a locking element releases either the winding contour or the adjusting contour depending on the direction of rotation. In doing so, the two contours can run on a common plane relative to a plane aligned perpendicular to the axis of rotation of the cutting head, and simultaneously remain distinct from one another. The forced guidance of the pawl is thus different for each contour and thus adjusted to the purpose. The locking element has, in particular, a radial surface with respect to the axis of rotation, which is part of the adjusting contour. In addition, the actuating element has, in particular, an axial surface with respect to the axis of rotation of the cutting head, which is part of the winding contour. The locking element is formed, in particular, as a tongue that is spring-loaded in the axial direction with respect to the axis of rotation.

An independent concept provides a cutting head comprising a housing, wherein the cutting head can be driven in a direction of rotation around an axis of rotation of the cutting head via the output shaft, a thread spool arranged in the housing for receiving at least one cutting line, an adjusting device, wherein the adjusting device is formed to adjust a free cutting line length of a cutting line depending on the centrifugal force, wherein the adjusting device comprises at least one pawl, wherein the adjusting device comprises an actuating element with at least one pawl stop that is connected to the thread spool in a rotationally fixed manner, wherein the at least one pawl is formed in such a way that it deflects from the pawl stop depending on the centrifugal force, whereby the thread spool rotates relative to the housing and feeds cutting line, wherein the actuating element comprises a winding contour and an adjusting contour different from the winding contour, wherein the at least one pawl has a guide element that interacts with either the winding contour or the adjusting contour depending on the direction of rotation of the actuating element relative to the housing, and wherein the actuating element has a crossing section where the winding contour and the adjusting contour intersect, wherein a locking element releases the winding contour or the adjusting contour at the crossing section depending on the direction of rotation.

In doing so, the two contours can run on a common plane relative to a plane aligned perpendicularly to the axis of rotation of the cutting head and simultaneously differ from each other. The forced guidance of the pawl is thus different for each contour and thus adapted to its purpose.

The locking element has, in particular, a radial surface with respect to the axis of rotation, which is part of the adjusting contour. In addition, the actuating element has, in particular, an axial surface with respect to the axis of rotation of the cutting head, which is part of the winding contour. The locking element is, in particular, formed as a tongue that is spring-loaded in the axial direction with respect to the axis of rotation.

### BRIEF DESCRIPTION OF THE DRAWINGS

Further features of the invention emerge from the description and the drawings, in which an exemplary embodiment of the invention described below in detail is depicted.

FIG. 1 shows, in a side depiction, a hand-held working device with a cutting head.

FIG. 2 shows, in a perspective depiction from above, a cutting head.

FIG. 3 shows, in a perspective depiction from below, the cutting head according to FIG. 2.

FIG. 4 shows, in a perspective depiction from above, the cutting head according to FIG. 2, dismantled into upper housing part, spool, spring and lower housing part.

FIG. 5 shows, in a perspective depiction from below, the cutting head according to FIG. 2, dismantled into upper housing part, spool, spring and lower housing part.

FIG. 6 shows, in a sectional depiction along the axis of rotation of the cutting head, the cutting head according to FIG. 2 in a wound position of the coupling device,

FIG. 7 shows, in a sectional depiction along the axis of rotation of the cutting head, the cutting head according to FIG. 2 in the operating position of the coupling position.

FIG. 8 shows, in a perspective exploded depiction, the upper housing part, the actuating element and the connection element.

FIG. 9 shows, in a perspective exploded depiction, the upper housing part, the shaft receiver and the adjustment device.

FIG. 10 to 16 show, in sectional depictions with a viewing direction of the direction of the axis of rotation towards the lower housing part, the cutting head in an adjustment cycle of the cutting line.

FIG. 17 to 24 show, in a sectional depiction with a viewing direction in the direction of the axis of rotation towards the lower housing part, the cutting head in an unwinding cycle of a cutting line and, in perspective depictions, the movement sequence of the guiding element of the pawl along the winding contour.

### DETAILED DESCRIPTION

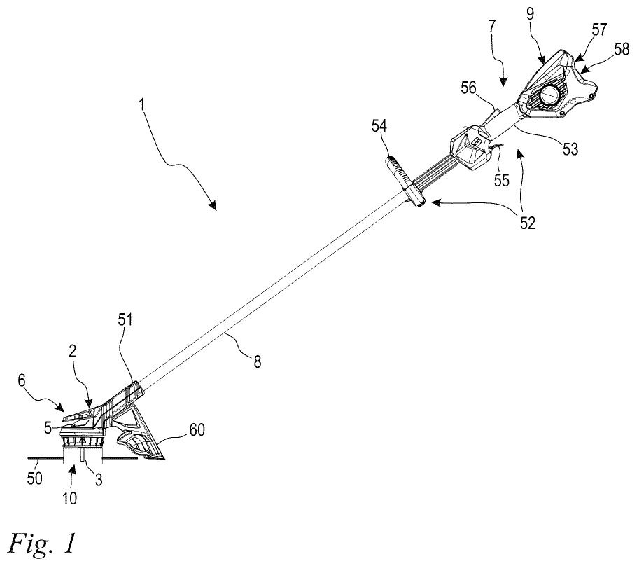

In a side depiction, FIG. 1 shows a hand-held tool—referred to below as a working device. Particular preferably, the working device is formed as a hand-held, portable working device. The term “portable working device” is to be understood to mean a working device, which is designed in such a way that it is to be carried by the operator during its intended use and guided by hand. Presently, the working device 1 is formed as a brush cutter.

As shown in FIG. 1, the working device 1 comprises a motor housing 2. A drive motor 5, which is formed as an electric motor, is arranged in the motor housing 2. The drive motor 5 is schematically depicted in FIG. 1 by a dashed rectangle. The drive motor 5 serves to drive a cutting tool, presently a cutting line 50, which is depicted schematically in FIG. 1. The cutting line 50 is attached to a cutting head 10. The cutting head 10, together with the cutting tool 50, is driven rotatably via an output shaft 3. The cutting line 50 serves to cut material such as grass, brush, or similar.

The working device 1 has a front end 6 and a rear end 7. The front end 6 is formed by the motor housing 2. A receiver 51 is provided on the motor housing 2. A shaft 8 is attached to the motor housing 2 via the receiver 51. The shaft 8 extends up to the rear end 7 of the working device 1, which is formed by a rear housing 9. A grip unit 52 is provided on the rear housing 9 and/or the shaft 8, which serves to guide the working device 1. The grip unit 52 comprises a rear, first handle 53 and a front, second handle 54. An actuating lever 55 for controlling the rotational speed of the drive motor 5 is allocated to the first handle 53. Furthermore, a locking lever 56 for releasing and for locking the actuating lever 55 is allocated to the first handle 53. The term “allocated” is to be understood to mean that the levers assigned to the handle are arranged opposite the handle in such a way that they can be actuated with the hand resting on the handle. Advantageously, the operating lever 55 and/or the locking lever 56 are part of the first handle 53. However, it can also be provided that the actuating lever 55 and/or the locking lever 56 are located outside the first handle 53. The second handle 54, which is formed as a loop handle, is arranged at a distance from the first handle 53 in the direction of the front end 6 of the working device 1. Furthermore, the rear housing 9 comprises a battery compartment 57 in which at least one battery pack 58 is arranged as an electrical energy source for the drive motor 5. The motor housing 2 and the rear housing 9 are connected to each other via the shaft 8. The shaft 8 can also be formed as a telescopic shaft. The cutting head 10 is covered by a protective hood 60 in the direction of the grip unit 52. The protective cover 60 is attached to the housing 2.

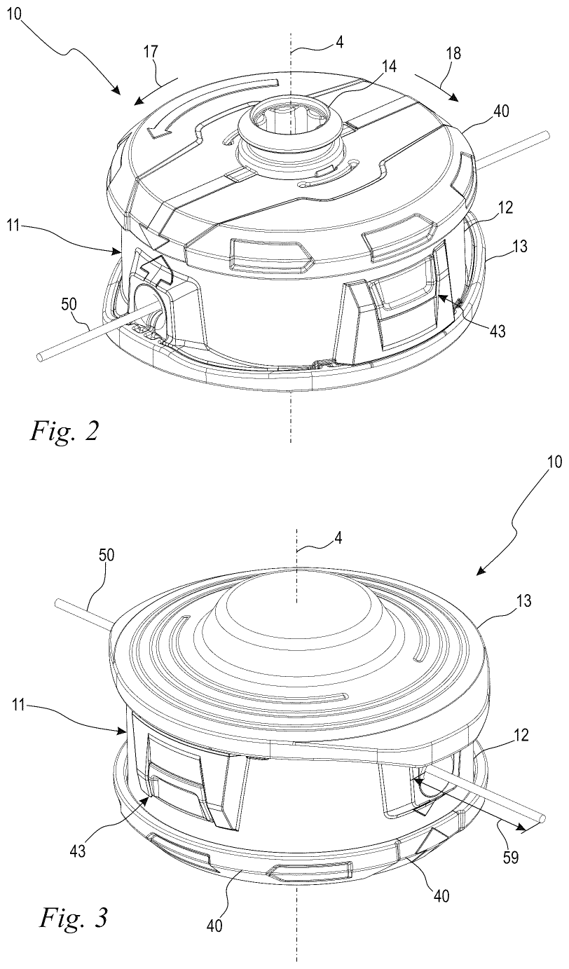

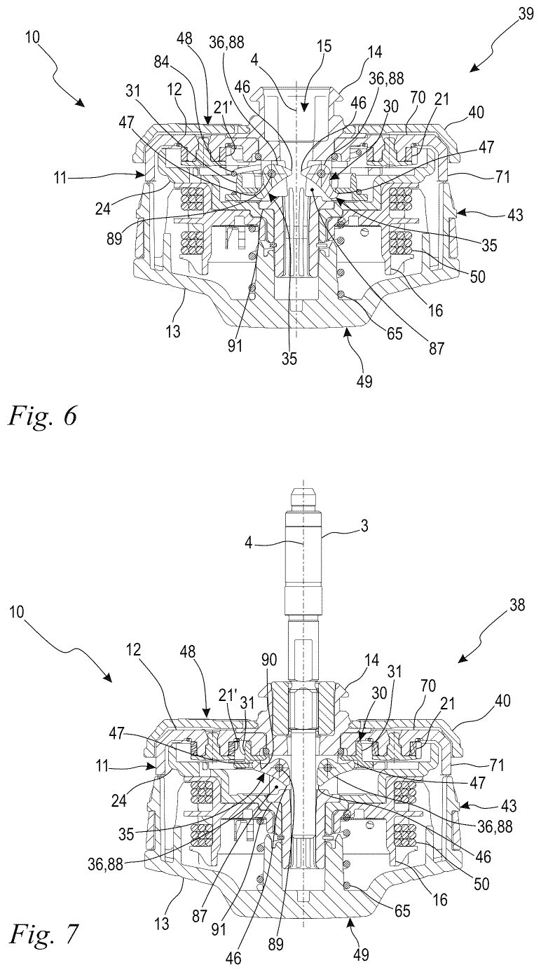

FIG. 2 shows a design of the cutting head 10. The cutting head 10 comprises a housing 11. Furthermore, the cutting head 10 comprises a shaft receiver 14 for connecting the cutting head 10 to the output shaft 3 of the working device 1. The shaft receiver 14 has a receiving chamber 15 (FIG. 6). To attach the cutting head 10 to the output shaft 3, the output shaft 3 is to be inserted into the receiving chamber 15 of the shaft receiver 14. The output shaft 3 and the shaft receiver 14 can preferably be connected to each other in a rotationally fixed manner with respect to the axis of rotation 4 of the cutting head 10 via a polygon connection and/or a spline shaft connection. In the exemplary embodiment, the shaft receiver 14 is formed as a hollow shaft. The cutting head 10 can be driven to rotate around an axis of rotation 4 via the output shaft 3. The axis of rotation 4 of the cutting head 10 corresponds to the axis of rotation of the output shaft 3. The cutting head 10 is preferably formed in such a way that it can be driven in a direction of rotation 17. In the intended operation of the cutting head 10 for cutting brush, grass and similar, the cutting head 10 is driven around its axis of rotation 4 in the direction of rotation 17.

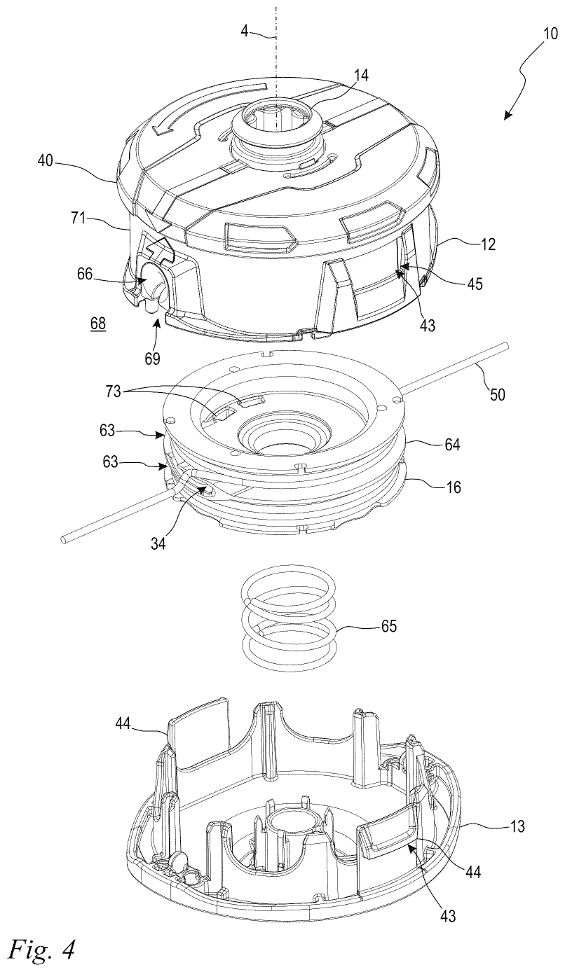

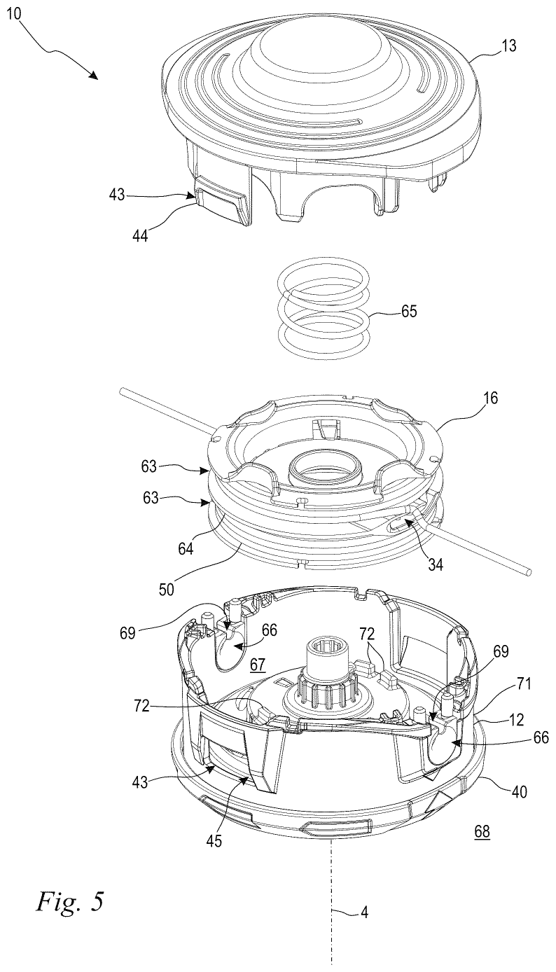

As shown in FIGS. 2 and 3, the housing 11 comprises an upper housing part 12 and a lower housing part 13. The upper housing part 12 and the lower housing part 13 are detachably connected to each other. The upper housing part 12 is, as shown in FIGS. 4 and 5, formed to be approximately cup-shaped. In other words, the upper housing part 12 has a base 70 extending substantially radially to the axis of rotation 4 of the cutting head 10 (FIGS. 6 and 7). Furthermore, the upper housing part 12 has a peripheral wall 71 extending substantially in the direction of the axis of rotation 4. The peripheral wall 71 of the upper housing part 12 abuts directly on the base 70 of the upper housing part 12. The upper housing part 12 rests directly on the lower housing part 13 with its peripheral wall 71. The connection between the upper housing part 12 and the lower housing part 13 is formed in such a way that it can preferably be produced and detached without tools. The connection is formed as a rotationally fixed connection with respect to the axis of rotation 4 of the cutting head 10. The connection is preferably formed as a snap connection 43. The snap connection 43 is formed by at least one hook 44 and at least one opening 45 (FIG. 5) of the snap connection 43 that interacts with the at least one hook 44. In the present exemplary embodiment, the at least one hook 44 is formed on the lower housing part 13. The at least one opening 45 is formed on the upper housing part 12, in particular on the peripheral wall 71 of the upper housing part 12. In the present exemplary embodiment, two hooks 44 and two openings 45 corresponding to the hooks 44 are provided. A different number of hooks 44 and openings 45 can also be expedient. Other connections for connecting the upper housing part 12 and the lower housing part 13 can also be expedient.

Furthermore, the cutting head 10 comprises the cutting tool 50, which in this case is formed as a cutting line. The at least one cutting line 50 projects from the housing 11 of the cutting head 10. The section of the cutting line 50 that projects from the housing 11 is referred to below as the free cutting line section 59 (FIG. 3).

As shown in FIGS. 2 and 3, the cutting head 10 comprises a grip element 40. The grip element 40 is arranged outside the housing 11 of the cutting head 10. The grip element 40 is formed as a grip plate. The grip plate projects radially beyond the adjacent housing part, at least partially, in relation to the axis of rotation 4 of the cutting head 10. In the mounted state of the cutting head 10, the grip element 40 is accessible to the operator, i.e. the operator can hold the cutting head 10 by the grip element 40. Presently, the grip element 40 is arranged above the upper housing part 12, in particular on the upper housing part 12. Thus, the grip element 40, in particular the grip plate, projects radially away from the axis of rotation 4 of the cutting head 10 and beyond the upper housing part 12. Thus, the operator can easily hold the cutting head 10 by the grip element 40. In the exemplary embodiment, the grip element 40 is connected to the shaft receiver 14 in a rotationally fixed manner with respect to the axis of rotation 4 of the cutting head 10. The connection between the shaft receiver 14 and the grip element 40 is preferably formed as a positive-locking connection. The grip element 40 rests, in particular, directly on the shaft receiver 14. The grip element 40 is preferably also fixedly connected to the shaft receiver 14 in the direction of the axis of rotation 4 of the cutting head 10, in particular held in a positive-locking manner on the shaft receiver 14. In an alternative design of the cutting head 10, it can also be provided that the shaft receiver 14 and the grip element 40 can also be formed as a single unit.

As shown in FIGS. 6 and 7, the cutting head 10 comprises an upper side 48 and a lower side 49. The upper side 48 of the cutting head 10 is the side facing towards the working device 1 when the cutting head 10 is attached to the output shaft 3 of the working device 1. The lower side 49 of the cutting head 10 is the side of the cutting head 10 facing towards the base 42, in intended operation of the cutting head 10, is attached to a working device 1 that the operator carries in front of them. Presently, the lower side 49 of the cutting head 10 is formed by the lower housing part 13. The upper side 48 of the cutting head 10 is formed by the grip element 40 of the cutting head 10. The upper housing part 12 is arranged between the grip element 40 and the lower housing part 13.

FIGS. 4 and 5 show the cutting head 10 in an at least partially disassembled state. The cutting head 10 comprises a spool 16 for receiving at least one cutting line. Furthermore, the cutting head 10 comprises a first spring element 65, wherein the sprig element presses the spool 16 against the upper housing 12 of the cutting head 10. The first spring element 65 is arranged between the lower housing part 13 and the spool 16. The first spring element 65 bears against an inner side of the lower housing part 13 and presses the spool 16, preferably directly, in the direction of the axis of rotation 4 of the cutting head 10 against the upper housing part 12 of the cutting head 10. The first spring element 65 is formed as a coil spring and is arranged coaxially with the axis of rotation 4 of the cutting head 10. At least one cutting line is attached to the spool 16. In the present embodiment, the spool 16 comprises a thread channel not depicted in more detail that connects two openings 34 of the thread spool 16 to each other. The two openings 34 are arranged at a uniform angular distance of approximately 180° from each other, relative to the axis of rotation 4 of the cutting head 10. To attach a cutting line to the cutting head 10, this is to be threaded through one of the two openings 34 in the spool 16 with one of its two ends until the cutting line protrudes from the other of the two opening 34 of the spool 16. The cutting line is then to be aligned with the thread channel in such a way that the two ends of the cutting line protruding from the openings 34 are approximately the same length. The cutting line can then be wound up. For this purpose, the spool 16 has two thread chambers 63. One end of the cutting line is wound into each thread chamber 63. The thread chambers 63 are separated from each other, in particular by a separating wall 64 extending radially to the axis of rotation of the cutting head 10. Instead of only one cutting line, two cutting lines can also be attached to the spool 16. For this purpose, openings not depicted in more detail are preferably provided on the spool 16, in particular in the respective thread chamber 63, into which the cutting line is to be inserted. The cutting line is folded over and wound up in the respective thread chamber 63 of the spool 16.

As shown in particular in FIGS. 4 and 5, the housing 11 of the cutting head 10 comprises at least one outlet opening 66 through which the cutting line projects from the housing 11. The cutting line is attached to the spool 16 and is guided via the outlet opening 66 of the housing 11 from an interior space 67 of the housing 11 into the external surroundings 68 of the cutting head 10. The spool 16 is arranged in the interior space 67 of the housing 11 of the cutting head 10. The interior space 67 is delimited by the housing 11 of the cutting head 10. In the present embodiment of the cutting head 10, two outlet openings 66 are provided. A different number of outlet openings 66 can also be expedient. The outlet opening 66 is formed substantially in the upper housing part 12, in particular on the peripheral wall 71 of the upper housing part 12. A slot 69 is provided at the outlet opening 66 in the upper housing part 12, via which the cutting line can be easily threaded into the outlet opening 66. The slot 69 allows the cutting line to be inserted into the outlet opening 66 in the direction of the axis of rotation 4 of the cutting head 10. The cutting line projects radially through the outlet opening 69 in relation to the axis of rotation 4 of the cutting head 10. If the cutting head 10 is mounted, the slot 69 at the outlet opening 69 is closed by the lower housing part 13.

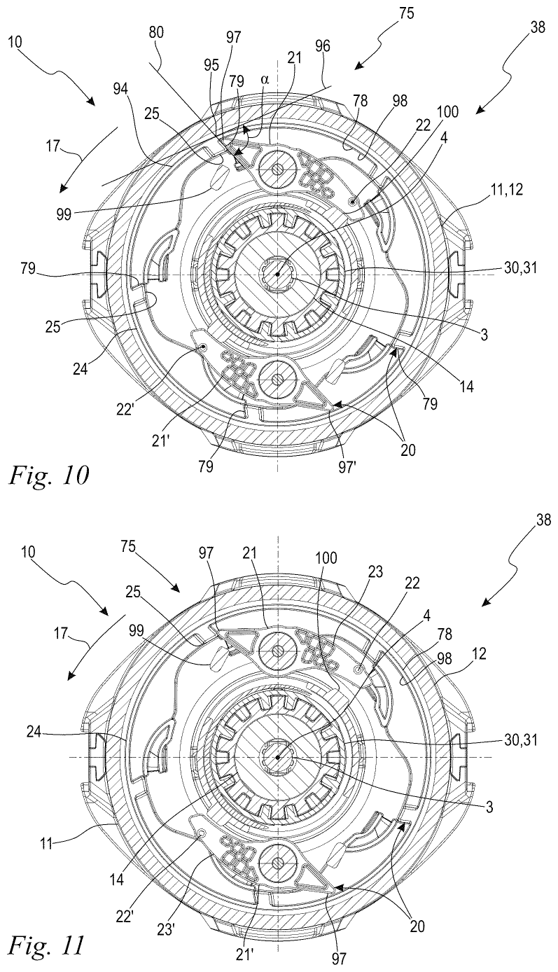

The cutting head 10 comprises an adjusting device 20 (FIG. 10) that enables automatic readjustment of the free cutting line section 59 during operation of the cutting head 10. The readjustment of the free cutting line section 59 is carried out by a relative rotation between the spool 16 and the housing 11 of the cutting head 10, whereby the cutting line is unwound from the spool 16 and guided out of the outlet opening 66. The adjusting device 20 is actuated by centrifugal force.

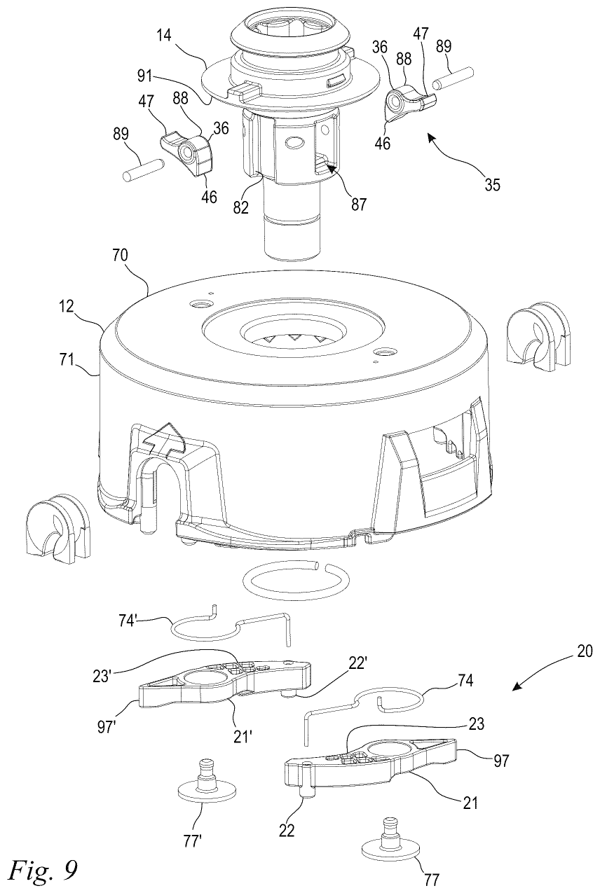

As shown in FIG. 9, the adjusting device 20 comprises at least one pawl 21. The at least one pawl 21 is fixedly arranged relative to the housing 11 of the cutting head 10 in the direction of the axis of rotation 4 of the cutting head 10. The pawl 21 is preferably arranged directly on the upper housing part 12 of the housing 11. The at least one pawl 21 is arranged, in particular, on the base 70 of the upper housing part 12.

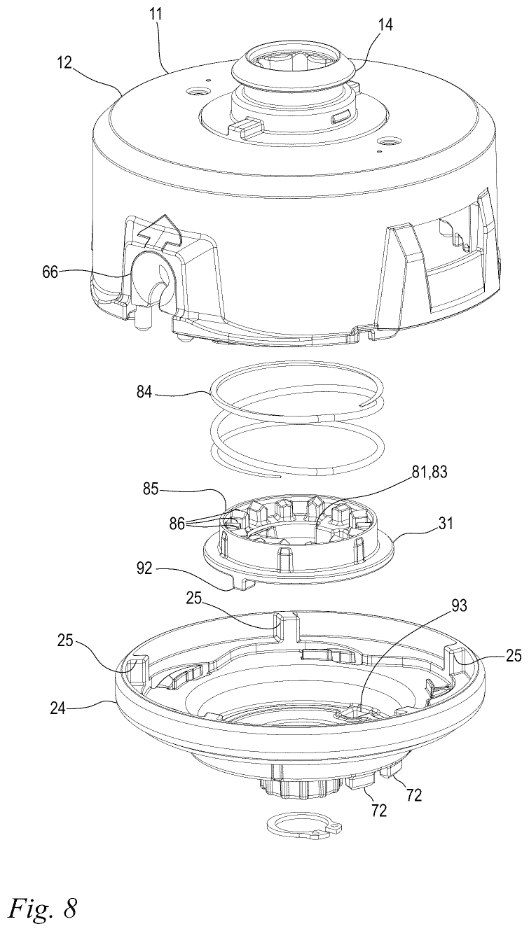

Furthermore, the adjusting device 20 comprises an actuating element 24, as shown in FIG. 8. The actuating element 24 is connected to the spool 16 in a rotationally fixed manner with respect to the axis of rotation 4 of the cutting head 10. In the present embodiment, the rotationally fixed connection between the actuating element 24 and the spool 16 is formed as a positive-locking connection. For this purpose, several pins 72 are formed on the actuating element 24 (FIGS. 5 and 8), which engage in corresponding openings 73 of the spool 16. The first spring element 65 presses the spool 16 against the actuating element 24, whereby the pins 72 of the actuating element 24 slide into the openings 73 of the spool 16 in the direction of the axis of rotation 4 of the cutting head 10. The actuating element 24 is supported against the spring force of the first spring element 65 on a shaft shoulder 91 of the shaft receiver 14 in the direction of the axis of rotation 4 of the cutting head 10. The pins 72 of the actuating element 24 and the openings 73 of the spool 16 are each formed on opposite sides of the actuating element 24 and the spool 16. Thus, a rotationally secure connection between the actuating element 24 and the spool 16 is ensured. In an alternative embodiment, the rotationally secure connection between the actuating element 24 and the spool 16 can also be produced by a different type of connection.

As shown in FIG. 8, the actuating element 24 comprises at least one pawl stop 25. The at least one pawl 21 is operatively connected to the at least one pawl stop 25. The at least one pawl 21 and the at least one pawl stop 25 are formed and arranged relative to each other in such a way that, depending on the centrifugal force, the relative rotation between the spool 16 and the housing 11 is released or blocked by the interaction of the at least one pawl 21 and the at least one pawl stop 25 (FIGS. 10 to 16). If the relative rotation between the spool 16 and the housing 11 is released, cutting line is fed to the free cutting line section 59. If the relative rotation between the spool 16 and the housing 11 is blocked, no cutting line is fed to the free cutting line section 59.

As shown in FIG. 9, the adjusting device 20 comprises a second spring element 74. The second spring element 74 pretensions the at least one pawl 21 into a locking position 75, in which the at least one pawl 21 acts against the pawl stop 25 and blocks the relative rotation between the spool 16 and the housing 11. The second spring element 74 is supported with its one end on the housing 11 and engages the at least one pawl 21 with its other end. The at least one pawl 21 is pivotably mounted on a bearing pin 77, in particular, relative to the housing 11. The bearing pin 77 is attached to the housing 11, in particular to the upper housing part 12, most particularly to the base 70 of the upper housing part 12. The rotational movement of the at least one pawl 21 is possible in a radial plane of the axis of rotation 4 of the cutting head 11. The radial plane is oriented perpendicularly to the axis of rotation 4 of the cutting head 11. Furthermore, the at least one pawl 21 comprises an actuating weight 23. Depending on the centrifugal force, the actuating weight 23 causes a corresponding torque, which counteracts the spring force of the second spring element 74. If the length of the free cutting line section 59 is reduced, for example due to wear of the cutting line during operation of the cutting head 10, the centrifugal forces acting on the cutting line are also reduced. Consequently, the torque acting on the spool 16, which tensions the at least one pawl stop 25, which is connected to the spool 16 in a rotationally fixed manner, against the at least one pawl 21, is also reduced. The actuating weight 23 of the at least one pawl 21, the second spring element 74, and the length of the free cutting line section 59 are coordinated in such a way that, if the free cutting line section 59 falls below a predetermined minimum length, the at least one pawl 21 disengages from the at least one pawl stop 23, and a relative rotation of the spool 16 and the housing 11 is allowed. The adjusting device 20 is in a feeding position 76, in which cutting line is fed to the free cutting line section 59. If the at least one pawl 21 again strikes the at least one pawl stop 25, the adjusting device 20 is again in the locking position 75. The adjustment process is described in detail with reference to FIGS. 10 to 16.

In the present exemplary embodiment, the cutting head 10 comprises two pawls 21, 21′. A different number of pawls 21, 21′ can also be expedient.

As shown in particular in FIGS. 6 and 7, the cutting head 10 comprises a coupling device 30. The coupling device 30 has an operating position 38 and a winding position 39. The coupling device 30 can be switched between the operating position 38 and the winding position 39. In the operating position 39 of the coupling device 30, the grip element 40 and the housing 11 are connected to one another in a rotationally fixed manner by the coupling device 30 with respect to the axis of rotation 4 of the cutting head 11. In the winding position 39 of the coupling device 30, the grip element 40 and the housing 11 are rotatable relative to each other with respect to the axis of rotation 4 of the cutting head 10. In addition, in the winding position 39 of the coupling device 30, the grip element 40 and the spool 16 are connected to one another in a rotationally fixed manner by the coupling device 30. In the winding position 39 of the coupling device 30, the operator can thus rotate the spool 16 relative to the housing 11 via the grip element 40 and thus wind the cutting line onto the spool 16.

As shown in FIGS. 6 and 7, the coupling device 30 has a connecting element 31 and a switching unit 35. The connecting element 31 and the switching unit 35 are formed to selectively establish a rotationally fixed connection between the housing 11 and the grip element 40. The connecting element 31 is switched by the switching unit 35 into the winding position 39 and into the operating position 38. The connecting element 31 is connected to the shaft receiver 14 in a rotationally secure manner with respect to the axis of rotation 4 of the cutting head 10. The connecting element 31 is movable relative to the shaft receiver 14 in the direction of the axis of rotation 4 of the cutting head 10. The connecting element 31 is linearly mounted on the shaft receiver 14 in the direction of the axis of rotation 4 of the cutting head 10. The connecting element 31 is formed as a connecting ring that surrounds the shaft receiver 14. The connecting ring is arranged coaxially to the shaft receiver 14. As shown in FIGS. 8 and 9, the connecting element 31 is held in a rotationally secure manner on the shaft receiver 14 by a spline shaft connection 81. The spline shaft connection 81 comprises at least one groove 82 and at least one driver 83 guided in the groove 82. In the present embodiment, the groove 82 is formed on the shaft receiver 14. The driver 83 is formed on the connecting element 31. In the present embodiment, two grooves 82 are provided on the shaft receiver 14 and two drivers 83 on the connecting element 31. A different number of grooves 82 and corresponding drivers 83 can also be expedient. Furthermore, the cutting head 10 comprises a third spring element 84, which is presently formed as a helical spring. The third spring element 84 acts on the connecting element 31 and pre-tensions it into the winding position 39. The third spring element 84 is supported on the housing 11, in particular on the upper housing part 12, in particular on the base 70 of the upper housing part 12.

As shown in FIG. 8, the connecting element 31 has an upper side 85 facing towards the base 70 of the upper housing part 12. A front toothing 86 is formed on the upper side 85 of the connecting element 31. In the operating position 38 of the coupling device 30, the connecting element 31 is pressed against the base 70 of the upper housing part 12 against the spring force of the third spring element 84, wherein the front toothing 86 of the connecting element 31 with a counter toothing of the upper housing part 12 forms a positive-locking connection. The present positive-locking connection is formed as a toothed face connection. In an alternative embodiment of the cutting head 10, other connection forms between the housing 11 and the connecting element 31 can also be expedient. Due to the positive-locking connection in the operating position 38 of the coupling device 30, the housing 11 and the connecting element 31 are connected to each other in a rotationally fixed manner with respect to the axis of rotation 4 of the cutting head 10. Since the shaft receiver 14 is connected to the connecting element 31 and the grip element 40 is connected to the shaft receiver 14 in a rotationally fixed manner, the housing 11 is coupled to the connecting element 31, the shaft receiver 14, and the grip element 40 in the operating position 38 of the coupling device 30 in a rotationally fixed manner. In the winding position 39 of the coupling device 30, the front toothing of the connecting element 31 and the counter teeth of the housing 11 are not engaged. The positive-locking connection between the connecting element 31 and the housing 11 is released. Thus, the housing 11 is also no longer coupled to the shaft receiver 14 and the grip element 40 in a rotationally fixed manner.

As shown in particular in FIGS. 6 and 9, the switching unit 35 comprises at least one switching element 36. In the present embodiment of the cutting head 10, two switching elements 36 are provided. A different number of switching elements 36 can also be expedient. The at least one switching element 36 comprises a first end 46 and a second end 47. In the winding position 39 of the coupling device 30, the first end 46 of the switching element 36 projects into the receiving space 15 of the shaft receiver 14. In the winding position 39 of the coupling device 30, the first end 46 of the switching element 36 projects into the receiving space 15 in such a way that, when the output shaft 3 is inserted, the first end 46 is contacted by the output shaft 3. If the output shaft 3 is fully inserted into the receiving space 15 of the shaft receptacle 14 (FIG. 7), the first end 46 of the switching element 36 is pushed out of the receiving space 15. The second end 47 of the switching element 36 is operatively connected to the connecting element 31. Against the spring force of the third spring element 84, the second end 47 of the switching element 36 presses the connecting element 31 against the base 70 of the upper housing part 12. The second end 47 of the switching element 36 preferably contacts the connecting element 31 directly. The second end 47 of the switching element 36 preferably contacts the connecting element 31 at a lower side 90 of the connecting element 31 facing towards the lower housing part 13. The coupling device 30 is switched from the winding position 39 to the operating position 38. In the preferred embodiment, the switching element 36 is formed as a pivot lever 88. The pivot lever 88 is arranged in the shaft receiver 14. The shaft receiver 14 has at least one holding opening 87 for this purpose, which runs through the peripheral wall of the shaft receiver 14. The pivot lever 88 is arranged in the retaining opening 87. The pivot lever 88 is pivotably mounted in the holding opening 87 by means of a pin 89.

If the cutting head 10 is again withdrawn from the output shaft 3, the connecting element 31 is pushed away from the base 70 of the upper housing part 12 by the spring force of the third spring element 84, whereby the first end 46 of the switching element 36 is moved, in particular pivoted, back into the receiving space 15 of the shaft receiver 14. The coupling device 30 is switched from the operating position 38 back to the winding position 39 (FIG. 6).

As shown in FIG. 6, the connecting element 31 and the actuating element 24 contact each other in the winding position 39 of the coupling device 30. In the winding position 39 of the coupling device 30, the connecting element 31 and the actuating element 24 are connected to each other in a rotationally secure manner, in particular in a positive locking manner, with respect to the axis of rotation 4 of the cutting head 10. The positive locking connection between the connecting element 31 and the actuating element 24 comprises a pin 92 formed on the connecting element 31 (FIG. 8), which engages in an opening 93 of the actuating element 24 corresponding to the pin 92. In the winding position 39 of the coupling device 30, the grip element 40 is connected to the spool 16 via the shaft receiver 14, the actuating element 24, and the connecting element 31 in a rotationally secure manner with respect to the axis of rotation 4 of the cutting head 10.

As shown in FIG. 7, the connecting element 31 and the actuating element 24 do not contact each other in the operating position 38 of the coupling device 30. The rotationally secure connection between the connecting element 31 and the actuating element 24 is released in the operating position 38 of the coupling device 30. The connecting element 31 is pressed against the upper housing part 12 by the switching element 36, whereby the pin 92 of the connecting element 31 is pushed out of the opening 93 of the actuating element 24. In the operating position 38 of the coupling device 30, the actuating element 24 with the spool 16 can be rotated relative to the connecting element 31, the shaft receptacle 14, and the grip element 40.

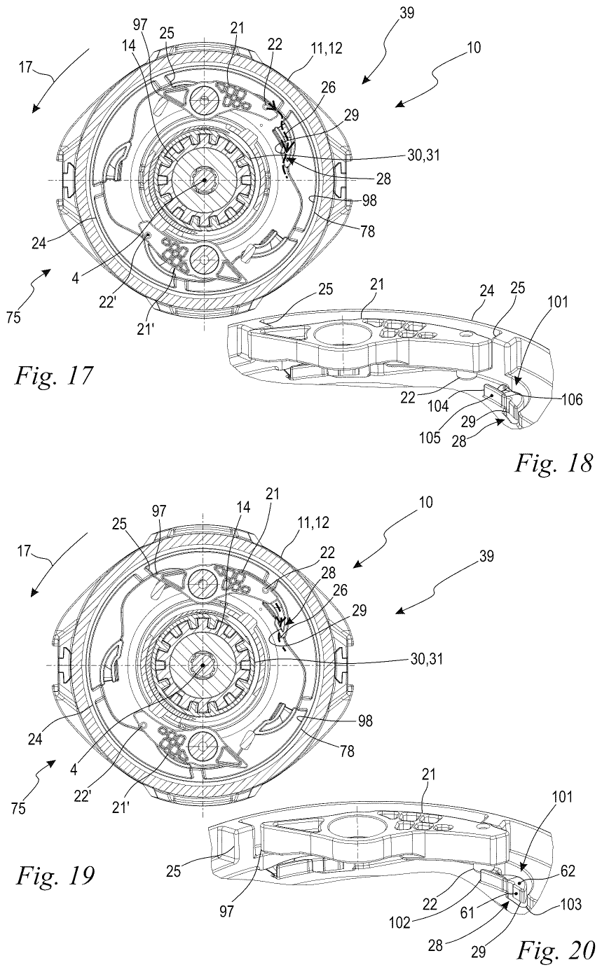

The cutting head 10 comprises two functions. The first function consists of automatic thread feed during operation of the cutting head. Depending on the centrifugal force acting on the cutting head 10, the adjusting device is actuated, which feeds the wound cutting line to the free cutting line section 59 on the spool 16. The second function of the cutting head 10 is to enable convenient winding of the cutting line onto the thread spool 16 when the cutting head 10 is mounted. The cutting head 10 is in the mounted state when the individual components of the cutting head 10 are put together. To unwind and wind the cutting line from and onto the spool 16, respectively, relative rotations of the spool 16 with respect to the housing 11 in opposite directions of rotation are required. For a better understanding, the automatic feeding of the cutting line, i.e. the unwinding of the cutting line from the spool 16, is explained by means of FIGS. 10 to 16, and the winding of the cutting line onto the spool 16 is explained by means of FIGS. 17 to 24.

FIGS. 10 to 16 show cross-sectional images of the cutting head 10 in a view from top to bottom, i.e. from the upper housing part 12 to the lower housing part 13, in various positions while feeding the cutting line. In these different positions, the cutting head 10 is in operation, i.e. the cutting head 10 is attached to an output shaft 3 of a working device 1, in particular a brush cutter, which in turn drives the cutting head 10 in the direction of rotation 17. The output shaft 3 is arranged in the receiving space 15 of the shaft receiver 14. Thus, the coupling device 30, in particular the switching unit 35, is actuated into the operating position 38, such that the connecting element 31 connects the output shaft 3 to the housing 11 via the shaft receiver 14 in a rotationally secure manner with respect to the axis of rotation 4 of the cutting head 10. The connecting element 31 is decoupled from the actuating element 24 and thus from the spool 16.

As shown in particular in FIG. 10, the adjusting device 20 is in the locking position 75, in which the adjusting device 20 connects the housing 11 to the spool 16 with respect to the axis of rotation 4 of the cutting head 10 in a rotationally secure manner. The at least one pawl 21 contacts the pawl stop 25 of the actuating element 24, whereby the spool 16 is also rotated in the direction of rotation 17 by the actuating element 24 and by the housing 11. The housing 11 and the spool 16 rotate in the direction of rotation 17 at the same rotational speed.

As shown in FIG. 10, the actuating element 24 comprises at least one pawl stop 25. The pawl stop 25 is formed by a projection on a peripheral collar 78 of the actuating element 24. The peripheral collar 78 completely surrounds the axis of rotation 4 of the cutting head 10. The peripheral collar 78 extends in the direction of the axis of rotation 4 of the cutting head 10. The pawl stop 25 extends radially from the collar 78 to the axis of rotation 4 of the cutting head 10. The pawl stop 25 has a stop surface 79 against which the pawl 21 rests in the locked position 75 of the adjusting device 20. The stop surface 79 defines a stop plane 80 that intersects the actuating element 24 at an outer periphery 94 in a line of intersection 95. Furthermore, a tangential plane 96 lies at the intersection line 95 on the outer peripheral 94 of the actuating element 24. The tangential plane 96 intersects the stop plane 80 at an angle α, wherein the angle α is opened towards the direction of rotation 17. The stop surface 79 of the pawl stop 25 is formed in such a way that the angle α in the exemplary embodiment is less than 90°, in particular less than 80°, and in particular less than 75°. The stop surface 79 abuts the inner surface 98 of the peripheral collar 78 of the actuating element 24. Here, the pawl stop 25 is formed on the peripheral collar 78 in such a way that they form a wedge-shaped receiver for the pawl 21. The pawl 21 itself has a wedge-shaped tip 97 which, in the locked position 75, rests against the stop surface 79 of the pawl stop 25. The wedge-shaped tip 97 of the pawl 21 rests in the recess formed by the pawl stop 25 and the peripheral collar 78. The wedge-shaped recess of the actuating element 24 ensures that the tip 97 of the pawl 21 is securely held against the actuating element 24 in the locked position 75.

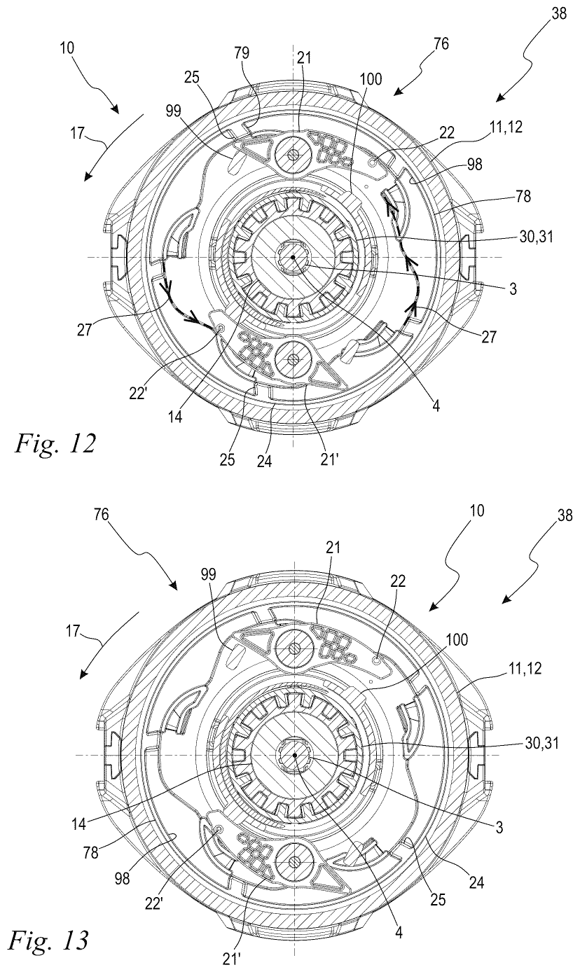

In FIG. 11, the cutting head 10 is shown in a state in which the adjusting device 20 transitions from the locking position 75 to the feeding position 76. The minimum length of the free cutting line section 59 is no longer required. Thus, the centrifugal force acting on the cutting line is reduced, whereby the torque applied to the spool 16 is also reduced that presses the pawl stop 25 of the actuating element 24 against the pawl 21. The actuating weight 23 of the pawl 21 exerts a torque on the pawl 21 that overcomes the spring force of the second spring element 74 and the torque applied to the spool 16. Thus, the pawl 21, with its wedge-shaped tip 97, is pivoted out of the pawl stop 25 of the actuating element 24. Here, the pawl 21 presses the actuating element 24 relative to the housing 11 in the direction of rotation 17. The tip 97 of the pawl 21 pivots in the direction of the axis of rotation 4 of the cutting head 10 until it avoids the pawl stop 25 (FIG. 12).

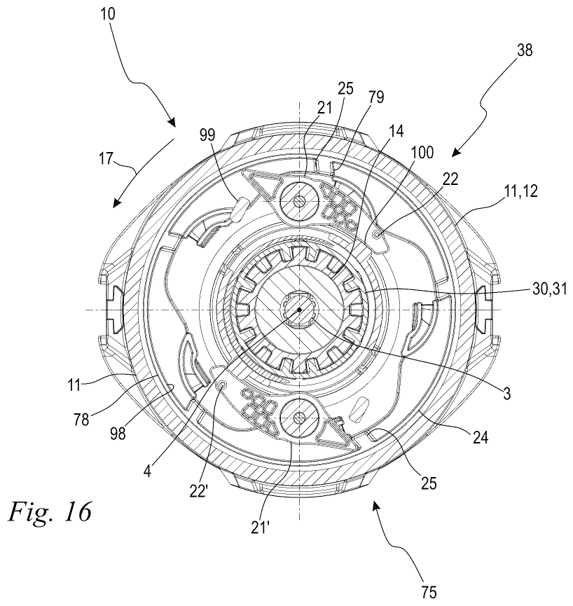

As shown in FIG. 12, the adjusting device 20 is in the feeding position 76. The pawl stop 25 no longer rests with its stop surface 79 against the pawl 21, in particular against the tip 97 of the pawl 21. The pawl 21 has moved out of the way of the pawl stop 25. In the feeding position 76, the housing 11 and the actuating element 24, in particular the spool 16 via the actuating element 24, are no longer connected to each other in a rotationally secure manner. While the housing 11 continues to rotate around the axis of rotation 4 of the cutting head 10 via the output shaft 3, the actuating element 24 with the spool 16 rotates relative to the housing 11 in the opposite direction of rotation 17 of the cutting head 10 (FIGS. 12 to 15). Here, cutting line is unwound from the spool 16, whereby the free cutting line section 59 is lengthened. The adjusting device 20 is in the feeding position 76. The relative rotation between the housing 11 and the actuating element 24 with the spool 16 is carried out until at least one pawl stop 25 abuts the pawl 21, whereby the housing 11 and the actuating element 24 with the spool 16 are connected to each other in a rotationally secure manner (FIG. 16). The adjusting device 20 is then in the locking position 75.

As shown in FIGS. 10 to 16, the actuating element 24 comprises several pawl stops 25. In the preferred embodiment of the cutting head 10, the actuating element 24 comprises five pawl stops 25. A different number of pawl stops 25 can also be expedient. In the exemplary embodiment, the multiple pawl stops 25 are arranged on the actuating element 24 at equal angular intervals around the axis of rotation 4 of the cutting head 10. In order to prevent a pawl stop 25 from skipping past a pawl 21, the at least one pawl 21 is guided, at least partially, on an adjusting contour 27 of the actuating element 24. The adjusting contour 27 is depicted by a dashed line in FIG. 12.

As shown in FIG. 9, the at least one pawl 21 comprises a guide element 22. The guide element 22 is formed fixed to the pawl 21. Preferably, the guide element 22 is formed integrally with the pawl 21. In the present embodiment, the guide element 22 is formed as a pin. Other designs for the guide element 22 can also be expedient. The guide element 22 is arranged at the end of the pawl 21 opposite the tip 97 of the pawl 21. The guide element 22 of the pawl 21 is formed to correspond with a contour 26, 27 of the actuating element 24.

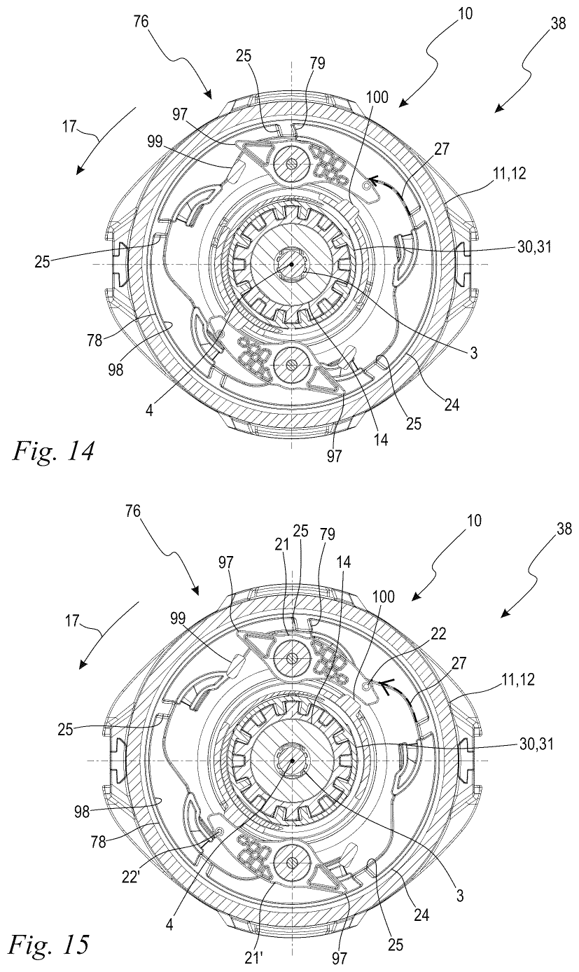

As shown in FIGS. 10 to 16, the guide element 22 projects towards the actuating element 24 in the direction of the axis of rotation 4 of the cutting head 10 and at least partially radially contacts the adjusting contour 27 formed on the actuating element 24. The adjusting contour 27 is formed in such a way that, after the tip 97 of the pawl 21 has cleared a pawl stop 25, the pawl 21 is pivoted in such a way that the tip 97 rotates outwards, in particular towards the inner surface 98 of the collar 78 of the actuating element 24. It is shown in FIGS. 14 and 15 in particular how the guide element 22 of the pawl 21 is moved towards the axis of rotation 4 of the cutting head 10 via the adjusting contour 27 during the relative rotation of the actuating element 24 and the housing 11. Thus, the tip 97 of the pawl 21 is pivoted outwards away from the axis of rotation 4 of the cutting head 10. The tip 97 is then again in a position where, with further relative rotation between the actuating element 24 and the housing 11, the pawl stop 25 abuts against the tip 97 of the pawl 21, such that the adjusting device 20 again assumes the locking position 75.

As shown in FIGS. 10 to 16, the cutting head 10 comprises a first pivot stop 99 in order to limit the pivoting movement of the pawl 21 in a first pivoting direction. The cutting head 10 comprises a second pivot stop 100 in order to limit the pivoting movement of the pawl 21 in a pivoting direction opposite to the first pivoting direction. The first pivot stop 99 and/or the second pivot stop 100 are formed on the housing 11, in particular the upper housing part 12. The first pivot stop 99 limits the pivoting direction of the tip 97 of the pawl 21 towards the axis of rotation 4 of the cutting head 10. The first pivot stop 99 is provided to contact the end of the latch 21 where the tip 97 of the pawl 21 is formed. The second pivot stop 100 limits the pivot direction of the other end of the pawl 21 towards the axis of rotation 4 of the cutting head 10, on which the guide element 22 is arranged. The second pivot stop 100 is provided to contact the other end of the pawl 21, on which the guide element 22 of the pawl 21 is formed. The pivot stops 99, 100 are formed on the housing 11, in particular on the upper housing part 12, in such a way that the pivot movement of the pawl 21 is as small as possible.

As shown in FIGS. 10 to 16, the adjusting device 20 in the preferred embodiment of the cutting head 10 comprises several, in particular two, pawls 21, 21′. The pawls 21, 21′ are preferably formed to be identical in construction. Furthermore, the adjusting device 20, in particular the actuating element 22, comprises five pawl stops 25. The number of pawl stops 25 is not equal to the number of pawls 21, 21′ and not equal to a multiple of the number of pawls 21, 21′. Moreover, it is provided that the multiple pawls 21, 21′ are alternately engaged with the pawl stops 25, i.e. the multiple pawls 21, 21′ are not simultaneously engaged with pawl stops 25. While in FIGS. 10 and 11, the one pawl 21 is engaged with a pawl stop 25, the other pawl 21′ is not engaged with any pawl stop 25. Only after relative rotation is carried out between the actuating element 24 and the housing 11 does the other pawl 21′ engage with a pawl stop 25, while the one pawl 21 does not contact any pawl stop 25. Due to the alternate engagement of the multiple pawls 21, 21′, the length by which the free cutting line section 59 is to be extended can be shortened. The adjustment of the cutting line is subject to a clearly finer adjustment increment. Thus, the length of the free cutting line section 59 can be kept as constant as possible. Since the cutting line is usually cut to length in the region of the free cutting line section 59 by a blade formed on the working device 1, the finer adjustment grid allows cutting line to be saved.

FIGS. 17 to 24 depict the winding process of the cutting line onto the spool 16, wherein the cutting head 10 is not arranged on any output shaft 3. The coupling device 30 is in the winding position 39, meaning that the grip element 40 is connected to the actuating element 24 and the spool 16 via the connecting element 31 in a rotationally secure manner. The operator can thus use the grip element 40 to rotate the spool 16 arranged in the housing 11 which is not accessible to the operator, relative to the housing 11. The adjusting device 20 is in the locking position 75. The actuating element 24 cannot thus be rotated relative to the housing 11 against the direction of rotation 17, i.e. in the opposite direction of rotation 18. The at least one pawl stop 25 of the actuating element 24 is blocked in the counter direction of rotation 18 by the at least one pawl 21. Thus, a relative rotation of the grip element 40, the connecting element 31, and the spool 16 in the opposite direction 18 to the housing 11 is also suppressed. In the direction of rotation 17, however, a relative rotation of the actuating element 24 to the housing 11 is possible.

As shown in FIGS. 17 to 24, the actuating element 24 comprises a winding contour 26. The winding contour 26 differs from the adjusting contour 27. The winding contour 26 is formed in such a way that, during a relative rotation of the actuating element 24 with respect to the housing 11 in the direction of rotation 17, the guide element 22 moves along the winding contour 26, in particular, glides along it. The guide element 22 jamming, in particular on the adjusting contour 27, and thus associated blockage of the actuating element 24 in the direction of rotation 17 is thus to be avoided.

The guide element 22 of the at least one pawl 21 interacts with the winding contour 26 or the adjusting contour 27, depending on whether the actuating element 24 is rotated relative to the housing 11 in the direction of rotation 17 or in the opposite direction of rotation 18. If the actuating element 24 is rotated relative to the housing 11 in the direction of rotation 17, the guide element 22 of the at least one pawl 21 thus moves along the winding contour 26. If the actuating element 24 is rotated relative to the housing 11 in the opposite direction of rotation 18, the guide element 22 of the at least one pawl 21 thus moves along the adjusting contour 27.

The winding contour 26 and the adjusting contour 27 are arranged on the same plane with respect to the direction of the axis of rotation 4 of the cutting head 10, as shown, for example, in FIG. 18. In other words, the winding contour 26 and the adjusting contour 27 are at the same height with respect to the axis of rotation 4 of the cutting head 10.

As shown in FIGS. 17 to 24, the actuating element 24 has an intersection section 28. The winding contour 26 and the adjusting contour 27 intersect in the intersection section 28. Furthermore, a locking element 29 is provided on the actuating element 24. The locking element 29 is arranged in the intersection section 28. Depending on the direction of rotation, the locking element 29 releases either the winding contour 26 or the adjusting contour 27 for the guide element 22. If the actuating element 24 is rotated relative to the housing 11 in the direction of rotation 17, then the locking element 29 releases the winding contour 26, whereby the guide element 22 is moved along the winding contour 26 in the intersection section 28. If the actuating element 24 is rotated relative to the housing 11 in the opposite direction of rotation 18, then the locking element 29 blocks the winding contour 26 and simultaneously releases the adjusting contour 27. Consequently, the guide element 22 is moved along the winding contour 26 in the intersection section 28. Through the intersection section 28 in connection with the locking element 29, the change contour 26 and the adjustment contour 27 can be arranged on the same plane with respect to the direction of the axis of rotation 4 of the cutting head 10, and yet be formed differently from each other.

As shown in FIGS. 17 and 18, the actuating element 24 is rotated relative to the housing 11 in the direction of rotation 17. The at least one pawl 21 and the at least one pawl stop 25 are formed in such a way that, when the actuating element 24 rotates relative to the housing 11 in the direction of rotation 17, the at least one pawl 21 slides over the at least one pawl stop 25. The actuating element 24 is not blocked by the operative connection of the at least one pawl stop 25 and the at least one pawl 21 when the actuating element 24 rotates relative to the housing 11 in the direction of rotation 17. The at least one pawl stop 25 and the at least one pawl 21 form a freewheel when the actuating element 24 rotates relative to the housing 11 in the direction of rotation.

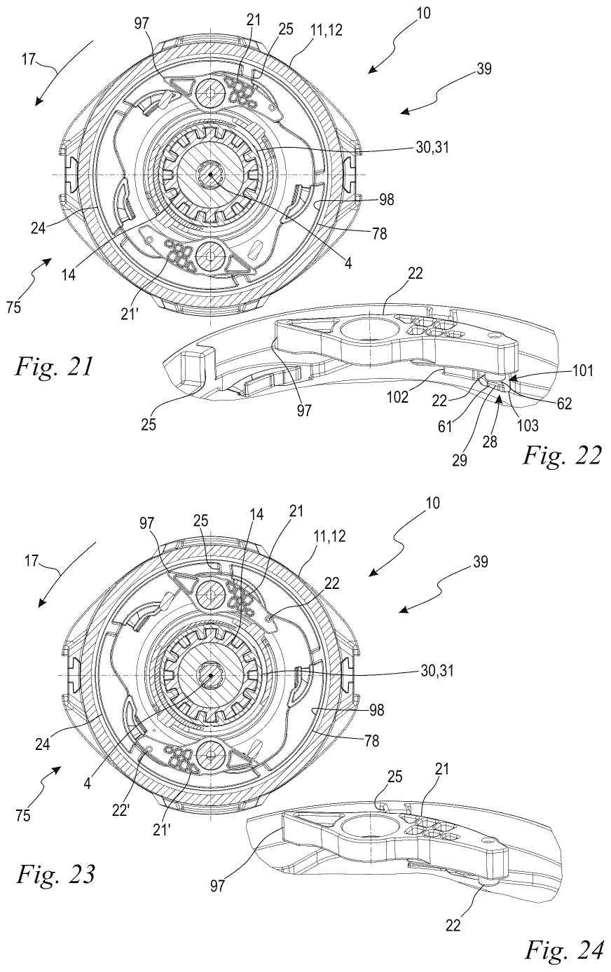

The tip 97 of the at least one pawl 21 glides over the pawl stop 25. Here, the guide element 22 is moved towards the winding contour 26. The actuating element 24 has a channel 101 for guiding the guide element 22. The channel 101 is part of the winding contour 26. As shown in FIGS. 19 and 20, the channel 101 is arranged on the actuating element 24 in such a way that, before the tip 97 of the at least one pawl 21 is no longer in contact with the pawl stop 25, the guide element 22 of the at least one pawl 21 is at least partially located in the channel 101. The guide element 22 of the at least one pawl 21 is guided in the channel 101 of the actuating element 24. The channel 101 extends from a channel inlet 102 to a channel outlet 103. The channel 101 is formed to be curved. The channel 101 opens via its channel outlet 103 into the intersection section 28 of the winding contour 26 and the adjusting contour 27. The locking element 29 is arranged in the channel 101. In the present embodiment, the locking element 29 is formed as a tongue that springs in the direction of the axis of rotation 4 of the cutting head 10. In the exemplary embodiment, the tongue is formed integrally with the actuating element 24. At the channel outlet 103 of the channel 101, the locking element 29 has a radial surface 61. The radial surface 61 is arranged radially to the axis of rotation 4 of the cutting head 10. The radial surface 61 is part of the adjusting contour 27. The radial surface 61 of the locking element 29 is arranged in the intersection section 28. Furthermore, the locking element 29 has an axial surface 62. The axial surface is aligned approximately axially to the axis of rotation 4 of the cutting head 10. The axial surface rises from the channel inlet 102 to the channel outlet 103 in the direction of the bottom 70 of the upper housing part 12. As shown in FIGS. 21 and 22, the locking element 29, in particular the tongue, must be pressed downwards by the guide element 22 in the direction of the lower housing part 13 so that the guide element 22 can glide along the winding contour 26 on the axial surface 62 through the channel 101. Here, the radial surface 61 of the locking element 29 is also pressed downwards towards the lower housing part 13, whereby the winding contour 26 is released.

As shown in FIGS. 23 and 24, the guide element 22 moves out of the channel 101 along the winding contour 26. Here, the guide element 22 of the at least one pawl 21 moves through the intersection section 28 and moves further along the winding contour 26. If the guide element 22 has left the channel 101, the locking element 29 springs back to its initial position. The channel 101 is again locked at its channel outlet 103 by the radial surface 61 of the locking element 21.

If the actuating element 24 rotates relative to the housing 11 in the opposite direction 18, the guide element 22 moves along the adjusting contour 27. The radial surface 61 of the locking element 29 is here part of the adjusting contour 27. At the intersection section 28, the radial surface 61 blocks the path into the channel 101 along the winding contour 26. The guide element 22 glides over the channel outlet 103 along the radial surface 61 until the guide element 22 encounters a wall section 104. The wall section 104 has an inner side 105 oriented towards the axis of rotation 4 of the cutting head 10. The wall section 104 has an outer side 106 facing away from the axis of rotation 4 of the cutting head 10 (FIG. 18). The outer side 106 of the wall section 104 is part of the adjustment contour 27. The inner side 105 of the wall section 104 is part of the winding contour 26, in particular part of the channel 101.

What is claimed is:

1. A cutting head (10), comprising:
a housing (11);
a shaft receiver (14) with a receiving space (15) for attaching the cutting head (10) to an output shaft (3) of a working device (1), whereby the cutting head (10) can be driven via the output shaft (3) around an axis of rotation (4) of the cutting head (10) in a direction of rotation (17);
a spool (16) arranged in the housing (11) for receiving a cutting line (19);
an adjusting device (20) configured to adjust a free cutting line length (59) of the cutting line (19) depending on a centrifugal force;
a grip element (40), the grip element (40) being accessible to an operator in a mounted state of the cutting head (10); and
a coupling device (30) movable between an operating position (38) and a winding position (39),
wherein, in the operating position (38), the coupling device (30) rotationally locks the grip element (40) to the housing (11) about the axis of rotation (4), and
wherein, in the winding position (39), the grip element (40) is rotatable relative to the housing (11) about the axis of rotation (4), and the coupling device (30) rotationally locks the grip element (40) to the spool (16) for winding the cutting line (19).

2. The cutting head according to claim 1,
wherein the coupling device (30) comprises
a connecting element (31) configured to rotationally lock the housing (11) and the grip element (40), and
a switching unit (35) configured to move the connecting element (31) between the winding position (39) and the operating position (38).

3. The cutting head according to claim 2,
wherein the switching unit (35) comprises at least one switching element (36), the at least one switching element (36) having an end (46) that projects into the receiving space (15) of the shaft receiver (14) in the winding position (39), such that insertion of the output shaft (3) into the shaft receiver (14) actuates the at least one switching element (36) to switch the coupling device (30) into the operating position (38).

4. The cutting head according to claim 3,
wherein the at least one switching element (36) is formed as a pivot lever,
wherein the pivot lever is arranged on the shaft receiver (15) and pivotably mounted,
wherein the pivot lever is configured to be actuated via the end (46) in the receiving space (15) of the shaft receiver (14), and
wherein another end (47) of the pivot lever acts on the connecting element (31).

5. The cutting head according to claim 2,
wherein the connecting element (31) is rotationally fixed to the housing (11) in the operating position (38) of the coupling device (30) by a front toothed connection.

6. The cutting head according to claim 1,
wherein the adjusting device (20) comprises at least one pawl (21) which is fixedly arranged in the direction of the axis of rotation (4) relative to the housing (11), and
wherein the adjusting device (20) comprises an actuating element (24) which is connected to the spool (16) in a rotationally fixed manner and has at least one pawl stop (25),
wherein the at least one pawl (21) is formed such that it deflects from the at least one pawl stop (25) depending on the centrifugal force, whereby the spool (16) rotates relative to the housing (11) and feeds the cutting line (19).

7. The cutting head according to claim 6,
wherein the actuating element (24) comprises
a winding contour (26) and
an adjusting contour (27) different from the winding contour (26),
wherein the at least one pawl (21) has a guide element (22), and
wherein the guide element (22), depending on a direction of rotation of the actuating element (24) relative to the housing (11), interacts either with the winding contour (26) or the adjusting contour (27).

8. The cutting head according to claim 7,
wherein the actuating element (24) has a crossing section (28) where the winding contour (26) and the adjusting contour (27) intersect,
wherein a locking element (29) releases the winding contour (26) or the adjusting contour (27) at the crossing section (28) depending on the direction of rotation.

9. The cutting head according to claim 8,
wherein the locking element (29) has a radial surface (61) forming part of the adjusting contour (27) and an axial surface (62) forming part of the winding contour (26) with respect to the axis of rotation (4), and
wherein the locking element (29) is formed as a tongue that is flexible in the direction of the axis of rotation (4) of the cutting head (10).

10. A cutting head, comprising:
a housing (11);
a shaft receiver (14) with a receiving space (15) for attaching the cutting head (10) to an output shaft (3) of a working device (1), whereby the cutting head (10) can be driven via the output shaft (3) around an axis of rotation (4) of the cutting head (10) in a direction of rotation (17);
a spool (16) arranged in the housing (11) for receiving a cutting line (19); and
an adjusting device (20) configured to allow a relative rotation between the spool (16) and the housing (11) and thereby adjust a free cutting line length (59) of the cutting line (19) depending on a centrifugal force,
wherein the adjusting device (20) comprises at least two pawls (21) which are centrifugally actuated and are formed to be fixed to the housing (11) in the direction of the axis of rotation (4) of the cutting head (10), and
wherein the cutting head (10) has at least one pawl stop (25) which is formed to be rotationally fixed to the spool (16) with respect to the axis of rotation (4) of the cutting head (10),
wherein the housing (11) is rotationally fixed to the spool (16) in the direction of rotation (17) of the cutting head (10) when at least one of the at least two pawls (21) is in contact with the at least one pawl stop (25),
wherein the housing (11) can be rotated relative to the spool (16) in the direction of rotation (17) of the cutting head (10) when neither of the at least two pawls (21) is in contact with the at least one pawl stop (25),
wherein a number of the at least one pawl stop (25) is not a multiple of a number of the at least two pawls (21), and
wherein the at least two pawls (21) and the at least one pawl stop (25) are arranged relative to each other such that the at least two pawls (21) are alternately engaged with the at least one pawl stop (25).

11. The cutting head according to claim 10,
wherein the at least two pawls (21) are formed such that they move away from the at least one pawl stop (25) depending on the centrifugal force, whereby the spool (16) rotates relative to the housing (11) and feeds the cutting line (19).

12. The cutting head according to claim 11, further comprising
an actuating element (24) comprising a winding contour (26) and an adjusting contour (27) different from the winding contour (26),
wherein the at least two pawls (21) each have a guide element (22) which, depending on a direction of rotation of the actuating element (24) relative to the housing (11), interacts either with the winding contour (26) or the adjusting contour (27).

13. The cutting head according to claim 12,
wherein the actuating element (24) has a crossing section (28) where the winding contour (26) and the adjusting contour (27) intersect,
wherein a locking element (29) releases the winding contour (26) or the adjusting contour (27) at the crossing section (28) depending on the direction of rotation.

14. The cutting head according to claim 13,
wherein the locking element (29) has a radial surface (61) which is part of the adjusting contour (27) and an axial surface (62) which is part of the winding contour (26) with respect to the axis of rotation (4), and
wherein the locking element (29) is formed as a tongue which is flexible in the direction of the axis of rotation (4) of the cutting head (10).
